(19) United States
(12) Patent Application Publication
(10) Pub. No.: US 2015/0272178 A1
(43) Pub. Date: Oct. 1, 2015

(54) POPCORN COOKING SET

(71) Applicants: Takuya Okemoto, Saitama (JP); ORIENT CORPORATION, Saitama (JP)

(72) Inventor: Takuya Okemoto, Saitama (JP)

(73) Assignees: ORIENT CORPORATION, Saitama (JP); Takuya Okemoto, Saitama (JP)

(21) Appl. No.: 14/291,257

(22) Filed: May 30, 2014

(30) Foreign Application Priority Data
Apr. 1, 2014 (JP) 2014-75410

(51) Int. Cl. A23L 1/18

(52) U.S. Cl. CPC A23L 1/1812

(57) ABSTRACT

A homemade popcorn cooking set is disclosed with which, at the time of selling, the kernels are subjected to no treatment work, such as seasoning; even after unsealing the casing, the popcorn can be topped (seasoned) with no problems; the quantity of kernels left unpopped is minimized; and the efforts and costs required for the treatment work are saved. A homemade popcorn set disclosed includes a container body, popcorn kernels, cooking oil packaged in a quantity suited for a quantity of the popcorn kernels, and a topping material, with which, by unsealing and putting the popcorn kernels and the cooking oil into the container body, and heating them in a microwave oven, popcorn is produced, and thereafter the topping material is sprinkled over the popcorn, the container body being then shaken to thereby cause the topping material to adhere to all over the popcorn.

### CROSS-REFERENCE TO RELATED APPLICATIONS

This application claims priority to JP Application No. 2014-75410, having a filing date of Apr. 1, 2014, the entire contents of which are hereby incorporated by reference.

### FIELD OF TECHNOLOGY

The following relates to a popcorn cooking set, and more particularly to a popcorn cooking set which is commercialized by providing materials necessary for popcorn cooking and a cooking container as a single pack, allowing popcorn to be simply cooked by heating the materials in a microwave oven.

### BACKGROUND

The popcorn which is cooked in a microwave oven has been conventionally available in various types, and is widely spread due to its convenience. With most of the types available, popcorn kernels (corn grains before being popped) are previously seasoned and coated with oil. Further, in the case where they are available with a cooking container, the popcorn produced fully fills the container in general after the kernels having been popped.

However, in the case of such conventional types of popcorn, the kernels are previously seasoned, therefore, there is a possibility that a problem in quality may be presented, and the seasoning work will require added efforts and costs. Further, if the popcorn kernels are previously oiled, there are presented problems that releasing them into a container may involve removal of the oil on a part of the kernels, and there is a possibility of the electromagnetic wave being not uniformly propagated during heating with a microwave oven, resulting in the kernels having been often left unpopped.

The present invention has been made to solve the aforementioned problems, and is intended to provide a popcorn cooking set with which, since the popcorn kernels are subjected to no treatment work, such as seasoning, at the time of selling, there is less of possibility that the quality may be deteriorated, and with which, at the time of popcorn cooking, topping (seasoning) can be made all over the popcorn, and the quantity of kernels left unpopped is minimized.

### SUMMARY

A device is disclosed for solving the aforementioned problems which provides a popcorn cooking set, including: individually packaged popcorn kernels, individually packaged cooking oil having a quantity corresponding to a quantity of the popcorn kernels, and an individually packaged topping material having a quantity corresponding to the quantity of the popcorn kernels, being packed together with one another in a container body for cooking, being made of paper, and at least an inner surface thereof being provided with an oil resistance, for popcorn produced by unpackaging the popcorn kernels and the cooking oil and putting them into the container body, and heating these in an microwave oven to pop the popcorn kernels; after unpackaging the topping material to be sprinkled over the popcorn, by sealing the container body and then shaking it, the topping material being enabled to be adhered to all over the popcorn, the individual packaging quantity of the popcorn kernels being set at a quantity providing, after the popcorn kernels having been popped, an airspace wide enough to allow the popcorn to be freely tumbled in a top portion of the container body for cooking at the time of the aforementioned shaking operation.

In one embodiment, the individual packaging quantity of the popcorn kernels is a quantity which would result in the airspace having a volume of one fifth to one fourth of the volume of the container body.

In another embodiment, the container body for cooking is of top open type, being of an upward expanding tapered shape, and in another embodiment, the container body for cooking has a quadrangle section, and a lid for opening or closing the top thereof is comprised of inner lids extended on opposed two sides, and outer lids extended on the other opposed two sides, being folded up on the inner lids and seizing each other.

In another embodiment, the topping material is one type or a plurality of types selected from among salt, grated cheese, pepper, basil, and sweet-taste material.

The popcorn cooking set accordingly, provides advantages that popcorn can be produced by putting the popcorn kernels and the cooking oil into the container body, and then heating them for a definite period of time in a microwave oven, and thereafter, by sprinkling the topping material over the popcorn and then shaking the container body, the topping material can be caused to adhere to all over the popcorn in the container body, and that, according to the user's taste, in addition to or in place of the topping material provided together with the popcorn kernels and the cooking oil, a seasoning, a sweetener, or the like, which he/she likes, may be added for enjoying a different taste, or a food, or the like, which is not too bulky, may be added to eat it after shaking the container body.

In addition, there are provided advantages that, at the time of selling, the popcorn kernels are subjected to no treatment work, thereby the quality being enhanced, and the efforts and costs required for the treatment work for commercialization being saved. Also, since the user puts the cooking oil into the container body by himself/herself, the cooking oil can be permeated through the whole of the popcorn kernels. Accordingly, the electromagnetic wave in the microwave oven uniformly spreads within the container body. Thus, the quantity of unpopped popcorn kernels is remarkably reduced.

### BRIEF DESCRIPTION

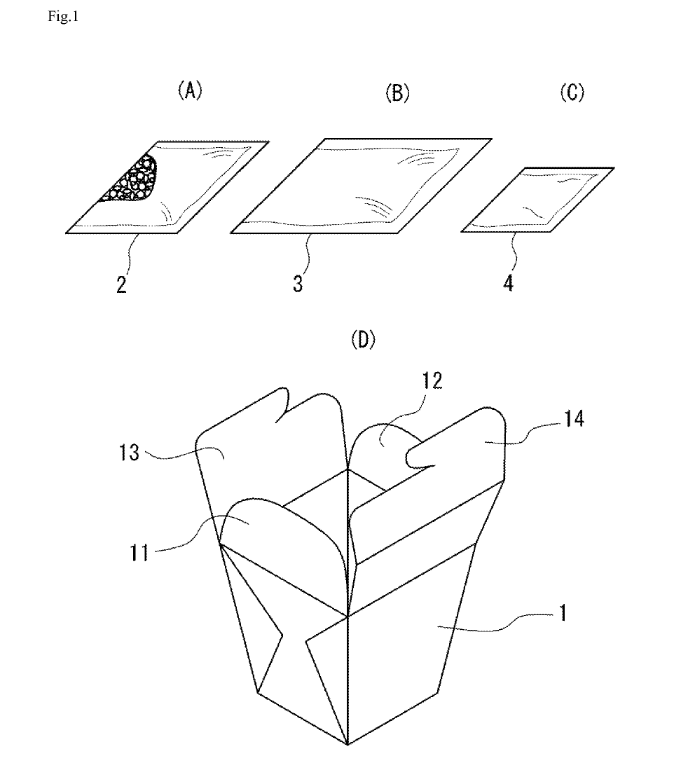

FIG. 1 is an exploded perspective view showing a configuration of a popcorn cooking set in accordance with the present invention; and

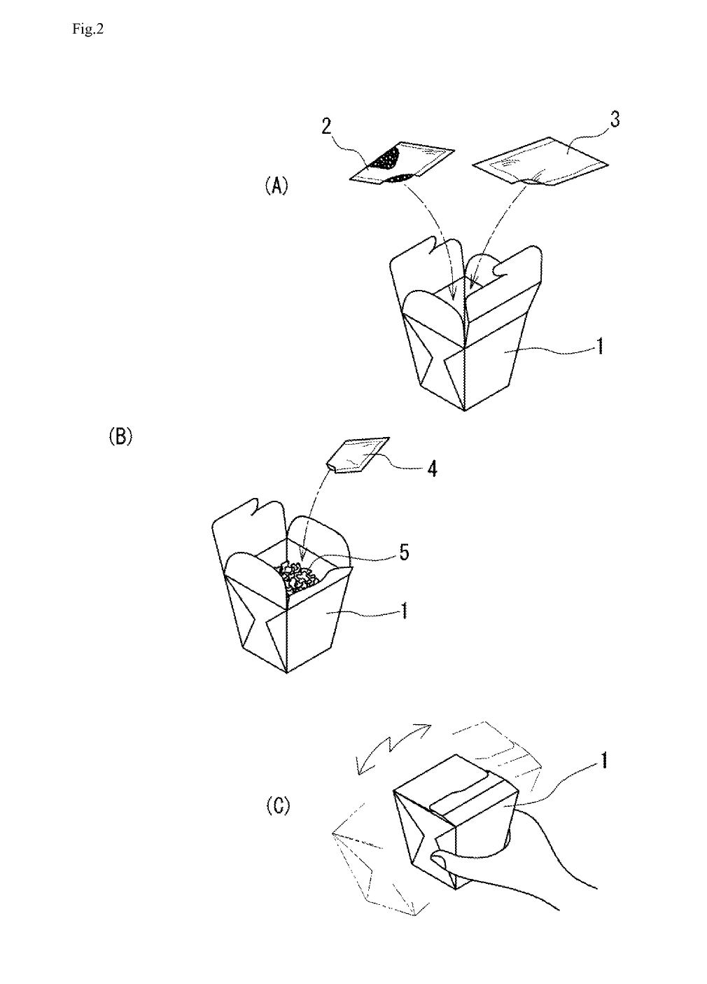

FIG. 2 is a figure illustrating the cooking method for the popcorn cooking set in accordance with the present invention.

### DETAILED DESCRIPTION

Hereinbelow, an embodiment of the present invention will be explained in detail with reference to the drawings. FIG. 1 is an exploded perspective view showing a configuration of a popcorn cooking set in accordance with the present invention, and as shown in the same figure, the popcorn cooking set in accordance with the present invention is comprised of a container body 1 providing a cooking container, and popcorn kernels 2, cooking oil 3 and a topping material 4. Each of these ingredients being individually packaged, the popcorn kernels 2, the cooking oil 3 and the topping material 4 being commercialized and sold, each being packed in the same container body 1 in an individually packaged state. A plurality of types of topping material 4 may be included in the same popcorn cooking set.

And, at the time of cooking, the popcorn kernels 2 and the cooking oil 3 are unpackaged and put into the container body 1 for cooking, and by heating them with a microwave oven, the popcorn kernels 2 are popped to obtain popcorn. Thereafter, the topping material 4 is unpackaged to sprinkle it over the popcorn, and the container body 1 for cooking is sealed and then shaken, thereby the topping material 4 being caused to adhere to all over the popcorn.

The container body 1 is made of paper, and is capable of being tightly sealed, at least an inner surface thereof being provided with an oil resistance, and being generally of top open type, as shown in an example, and preferably of an upward expanding tapered shape. The sectional shape thereof is not limited to a quadrangle, and may be a hexagon, a circle, an ellipse, or any other shape. The top has a lid which can be opened and closed, the lid being closed at the time of heating with a microwave oven, and at the time of shaking following the later described topping.

In order to eliminate the possibilities that popping at the time of cooking could involve the oil being splashed, and a shaking operation following the topping could involve the oil or topping materials being splashed, the lid on the top should be provided with a sealing property rather than a lid constituted by a single member without a sealing property. For this, in the case where the container body 1 has, for example, a quadrangle section, opposed two sides of the four sides are extended by a shorter length to provide inner lids 11, 12, while the other opposed two sides being extended by a longer length to provide outer lids 13, 14 which can seize each other. Thus, by folding up the outer lids 13, 14 on the inner lids 11, 12 and seizing them each other, the inside of the container body 1 can be brought into a tightly sealed state.

The popcorn kernels 2, which are individually packaged and packed in the container body 1, are general corn grains which are popped by heat, the individual packaging quantity thereof depending upon the volume of the container body 1. In other words, the individual packaging quantity thereof is a quantity providing, after being popped, an airspace wide enough to allow popcorn 5 to be freely tumbled in a top portion of the container body 1 at the time of shaking following the topping. The volume of the airspace is, for example, approximately one fifth to one fourth of the volume of the container body 1.

As the cooking oil 3, palm oil or edible oil is used, and the individual packaging quantity thereof is a quantity corresponding to the quantity of the popcorn kernels 2, in other words, a quantity which is required for cooking the popcorn kernels 2, being neither excessive nor insufficient. Further, the topping material 4, which is individually packaged by a quantity likewise corresponding to the quantity of the popcorn kernels 2, is a condiment for seasoning the popcorn 5, and possible topping materials include, for example, salt, grated cheese, pepper, basil, and a sweet-taste material, one type or a plurality of types being selected from among those (the plurality of topping materials being separately individually packaged).

In the case where the popcorn cooking set in accordance with the present invention is to be used, the lid of the container body 1 is first opened to take out packages of the popcorn kernels 2, the cooking oil 3, and the topping material 4, which are contained, and among them, the packages of the popcorn kernels 2 and the cooking oil 3 are unsealed before being put into the container body 1. Then, by folding inside the inner lids 11, 12, and folding up the outer lids 13, 14 thereon, the container body 1 is brought into a tightly sealed state. In that state, the container body 1 is heated in a microwave oven for a definite period of time for popping the popcorn kernels 2 to provide the popcorn 5.

After the popcorn 5 having been produced, the lid of the container body 1 is opened, and the package of the topping material 4 is unsealed before being sprinkled over the popcorn 5, then the lid being again closed to bring the container body 1 into a tightly sealed state. In that state, by shaking the container body 1, the topping material 4 can be adhered to all over the popcorn 5 inside the container body 1. According to the user's taste, in addition to or in place of the topping material 4 provided together with the popcorn kernels 2 and the cooking oil 3, a seasoning, a sweetener, or the like, which he/she likes, or depending upon the case, a food, or the like, which is not too bulky, may be added before shaking the container body 1.

Hereinabove, the present invention has been explained in detail to some extent, and about the most preferred embodiment, however, since it is obvious that a wide range of different embodiments can be made without departing from the spirit and scope of the present invention, it is to be understood that the present invention is not limited to the specific embodiment thereof except as defined in the appended claims.

What is claimed is:

1. A popcorn cooking set, comprising:
individually packaged popcorn kernels;
individually packaged cooking oil having a quantity corresponding to a quantity of said popcorn kernels; and
an individually packaged topping material having a quantity corresponding to the quantity of said popcorn kernels, being packed together with one another in a container body for cooking, being made of paper, and at least an inner surface thereof being provided with an oil resistance, whereby, popcorn produced by unsealing and putting said popcorn kernels and said cooking oil into said container body, and heating these in an microwave oven to pop said popcorn kernels; and whereby after unsealing said topping material to be sprinkled over the popcorn, by sealing said container body and then shaking it, said topping material being adhered to all over the popcorn, and wherein the individual packaging quantity of said popcorn kernels being set at a quantity providing, after said popcorn kernels having been popped, an airspace wide enough to allow the popcorn to be freely tumbled in a top portion of said container body for cooking at the time of the aforementioned shaking operation.

2. The popcorn cooking set according to claim 1, wherein the individual packaging quantity of said popcorn kernels is a quantity which would result in said airspace having a volume of one fifth to one fourth of the volume of said container body.

3. The popcorn cooking set according to claim 1, wherein said container body for cooking is of top open type, being of an upward expanding tapered shape.

4. The popcorn cooking set according to claim 1, wherein said container body for cooking has a quadrangle section, and a lid for opening or closing the top thereof is comprised of inner lids extended on opposed two sides, and outer lids extended on the other opposed two sides, being folded up on said inner lids and seizing each other.

5. The popcorn cooking set according to claim 1, wherein said topping material is one type or a plurality of types selected from among salt, grated cheese, pepper, basil, and sweet-taste material.
